(19) United States
(12) Patent Application Publication
(10) Pub. No.: US 2020/0078900 A1
(43) Pub. Date: Mar. 12, 2020

(54) METHOD FOR CLEANING A BLADE-ROOT RECEIVING GROOVE

(71) Applicant: SIEMENS AKTIENGESELLSCHAFT, MÜNCHEN (DE)

(72) Inventors: Artem Bork, Köln (DE); Kai Mielich, Hilden (DE); Thomas Meyer, Gigon (ES)

(21) Appl. No.: 16/610,088

(22) PCT Filed: May 3, 2018
(86) PCT No.: PCT/EP2018/061363

§ 371 Date: Nov. 1, 2019

(30) Foreign Application Priority Data
May 29, 2017 (DE) 10 2017 208 949.0

(51) Int. Cl. B24B 27/033; B08B 1/00; B24B 19/02; F01D 25/00

(52) U.S. Cl. CPC B24B 27/033; B08B 1/005; F01D 25/002; B24B 19/02; B08B 1/008

(57) ABSTRACT

A method for cleaning a receiving groove formed on a rotor of an axial flow machine, the receiving groove serving to receive a blade root of a rotor blade is provided. In the method, an elongate base body of a machining tool, the base body having an abrasive surface at least in regions, is introduced into the receiving groove and therein is moved back and forth while machining is performed, wherein the outer contour of the base body is adapted to the contour of the receiving groove to be cleaned, in such a manner that when the base body is in the state inserted in the receiving groove it contacts the wall of the receiving groove in a substantially form-fitting manner such that it acts as a guide body during the back-and-forth movement. Also provided is a machining tool for carrying out the method.

### CROSS-REFERENCE TO RELATED APPLICATIONS

This application claims priority to PCT Application No. PCT/EP2018/061363, having a filing date of May 3, 2018, which is based on German Application No. 10 2017 208 949.0, having a filing date of May 29, 2017, the entire contents both of which are hereby incorporated by reference.

### FIELD OF TECHNOLOGY

The following relates to a method for cleaning a receiving groove formed on a rotor of an axial flow machine, the receiving groove serving to receive a blade root of a rotor blade, in which an elongate main body of a dressing tool, the main body being provided with at least one abrasive surface at least in some region or regions, is introduced into the receiving groove and is moved back and forth therein while dressing is performed. The following furthermore relates to a dressing tool for carrying out a method of this kind.

### BACKGROUND

In axial flow machines, e.g. in turbines or compressors, the blade roots of the rotor blades are held in receiving grooves provided in the rotor, which are formed onto equidistant spacings along the circumference of a shaft or of a wheel disk of the rotor and extend substantially in the axial direction of the turbomachine. Here, the contour of the receiving grooves corresponds to the contour of the blade roots to be received, with the result that the blade roots can be inserted into the receiving grooves in an axial direction and seated in a form-fitting manner in the respective receiving groove in the installed state. A contour of the receiving grooves and corresponding blade roots which is sufficiently well known and used in many contexts is the dovetail contour or firtree contour.

During the operation of the turbomachine, the rotor blades are subject to high stresses, which may lead to the formation of unwanted oxide layers in the region of the receiving grooves. Such oxide layers must be removed at regular intervals in the context of maintenance or repair work. Currently, diamond files are usually used for this purpose. Sandpaper is also widely used. In both cases, the work is very laborious since some regions of the receiving groove are accessible only with difficulty. Manual dexterity is furthermore also required to achieve a uniform result of work, however.

### SUMMARY

An aspect relates to providing an alternative method of the type stated at the outset and an alternative dressing tool for carrying out a method of this kind.

To achieve this aspect, embodiments of the present invention provides a method of the type stated at the outset which is characterized in that the outer contour of the main body is matched in such a way to the contour of the receiving groove to be cleaned that, when the main body is in the state inserted into the receiving groove, it rests against the wall of the receiving groove in a substantially form-fitting manner in such a way that it acts as a guide body during the back-and-forth movement. By virtue of such a configuration of the main body, even regions of the receiving groove which can be reached manually only with difficulty are easy to dress. In addition, the requirements in terms of manual dexterity of the person carrying out the dressing are relatively low.

It is advantageous if the at least one abrasive surface is pressed against the wall of the receiving groove by a spring force during the dressing process. In corresponding fashion, automatic feeding of the abrasive surface to the receiving groove wall to be dressed is accomplished by means of the spring force. In addition, however, unwanted wedging of the main body within the receiving groove while the back-and-forth movement is being performed is also counteracted in an effective manner.

The spring force is adjustable, thereby improving the flexibility of dressing.

According to one embodiment of the present invention, the main body is moved manually within the receiving groove. Costs for the dressing tool are correspondingly low.

To achieve the aspect stated at the outset, embodiments of the present invention furthermore provides a dressing tool for carrying out the method according to embodiments of the invention, comprising an elongate main body provided with at least one abrasive surface, the outer contour of which is matched in such a way to the contour of the receiving groove to be cleaned that it can be inserted in a substantially form-fitting manner into the receiving groove and acts as a guide body.

According to one embodiment of the dressing tool according to embodiments of the invention, rolling elements protrude from the bottom side of the main body, facilitating the movement of the main body through the receiving groove.

The rolling elements are arranged on a rolling element plate, which is held on the main body in such a way as to be downwardly movable against the spring force of at least one return spring, wherein an adjusting means is provided, upon the actuation of which the plate is pressed resiliently downward against the spring force of the at least one return spring. Thanks to such a design, the main body, together with the at least one abrasive surface, is pressed against the wall of the receiving groove by means of the adjusting means during the back-and-forth movement through a receiving groove to be cleaned, wherein the desired flexibility is provided by the at least one return spring.

The adjusting means or adjustment has an adjusting screw, which is screwed from above into a through hole in the main body, the through hole being provided with an internal thread and extending as far as the plate, and has a compression spring accommodated in the through hole, which is supported, on the one hand, against the adjusting screw and, on the other hand, against the plate. In this way, a simple and inexpensive construction is achieved.

It is advantageous if the at least one abrasive surface is designed as a grinding surface, in particular in the form of a diamond coating. By means of such a diamond coating, it is possible to dress even materials of extremely high strength.

According to one embodiment of the present invention, the at least one abrasive surface is fastened detachably on the main body, in particular in the form of a tool plate, which is provided with the abrasive surface and is accommodated in a recess formed in the main body. Detachable fastening of the abrasive surface is advantageous because worn abrasive surfaces can be readily replaced. Accommodation in a recess formed in the main body counteracts unintentional slipping of the abrasive surface.

According to one embodiment of the dressing tool according to the invention, the at least one abrasive surface is arranged on an upward-facing surface section of a laterally protruding projection of the main section.

The main body is divided into three parts in the longitudinal direction, which are fastened to one another by means of quick release fasteners. Accordingly, the main body can be disassembled for transportation and can be stowed more easily.

It is advantageous if an upward-protruding handle is secured on the main body, facilitating the handling of the dressing tool.

### BRIEF DESCRIPTION

Some of the embodiments will be described in detail, with reference to the following figures, wherein like designations denote like members, wherein:

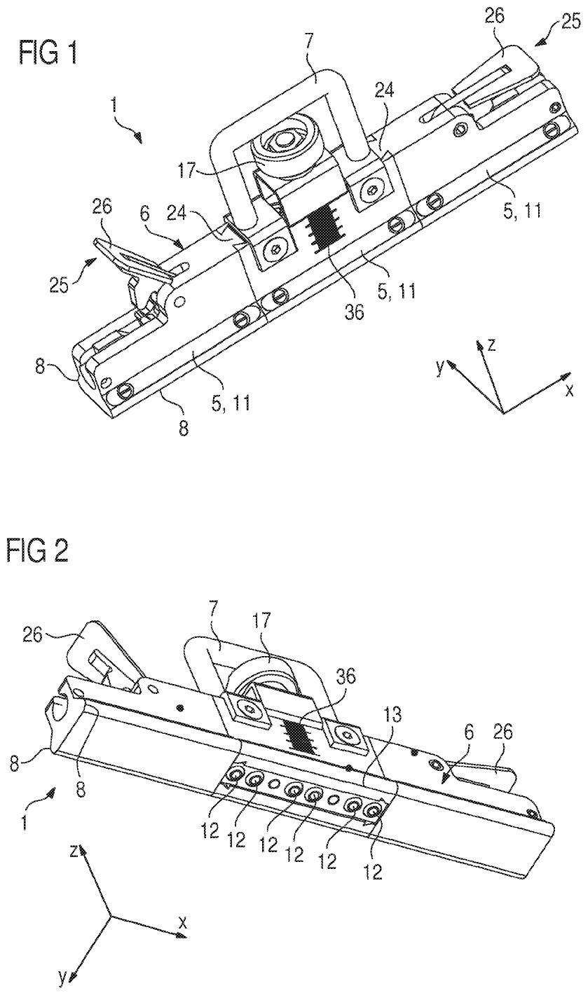

FIG. 1 shows a schematic perspective plan view of a dressing tool according to one embodiment of the present invention;

FIG. 2 shows a perspective bottom view of the dressing tool illustrated in FIG. 1;

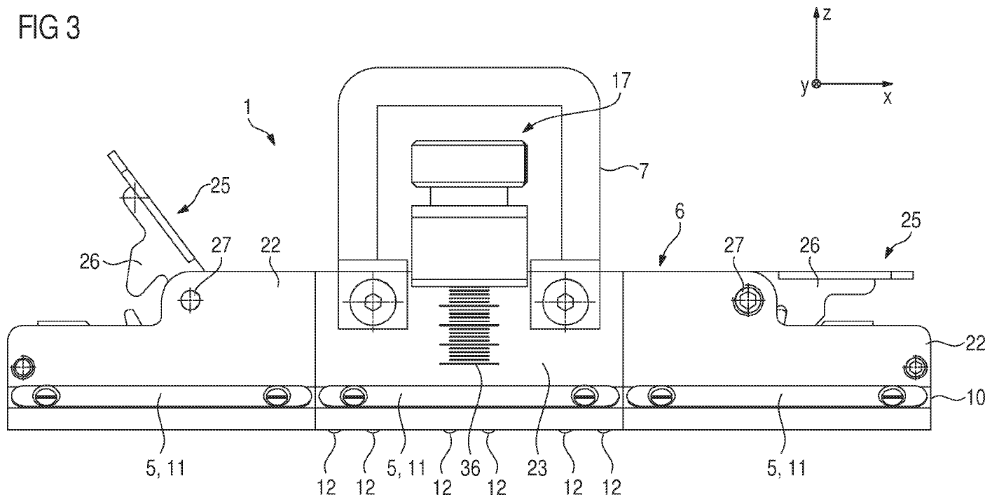

FIG. 3 shows a side view of the dressing tool;

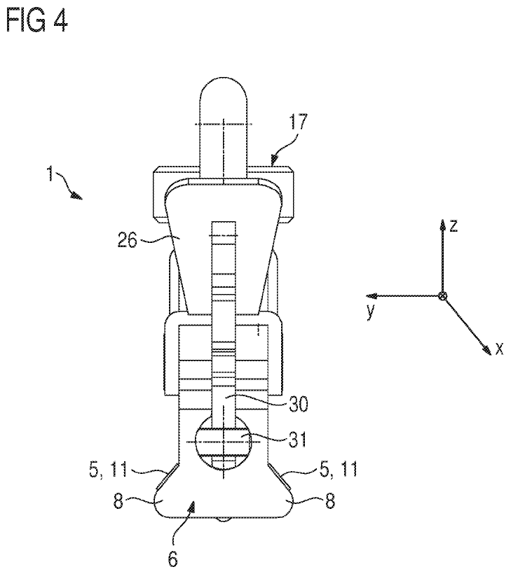

FIG. 4 shows an end view of the dressing tool;

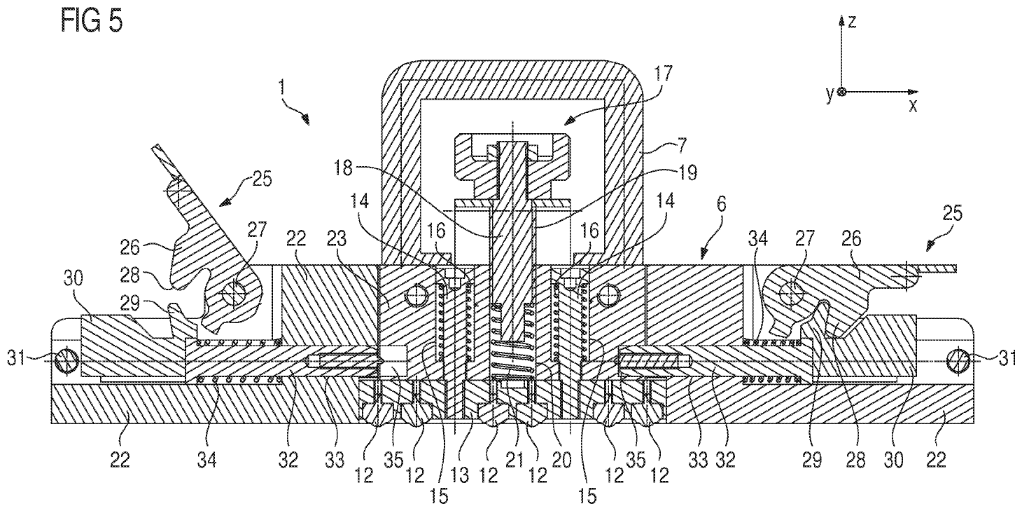

FIG. 5 shows a sectioned side view of the dressing tool, and

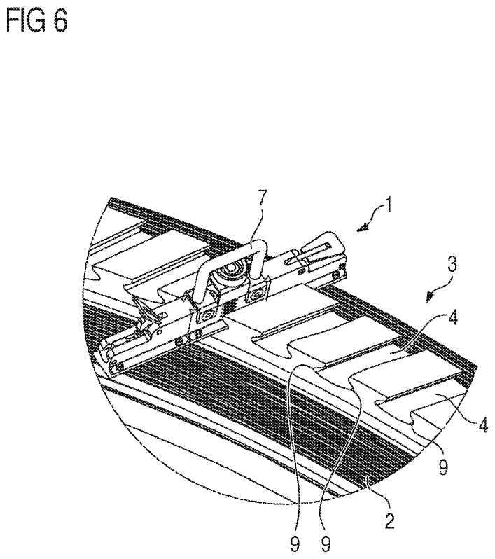

FIG. 6 shows a view of the dressing tool during the cleaning of a receiving groove formed in a rotor of an axial flow machine.

### DETAILED DESCRIPTION

The figures show a dressing tool 1 according to one embodiment of the present invention. The dressing tool 1 is used to clean receiving grooves which are formed in a rotor 2 of an axial flow machine 3, illustrated only in part in FIG. 6, and in which the blade roots of the rotor blades are received in a known manner. As main components, the dressing tool 1 comprises a main body 6, which has an abrasive surface 5, and an upward-protruding handle 7 arranged on the main body.

The main body 6 is of elongate design, wherein, in the present case, the longitudinal direction coincides with the X direction of the coordinate system depicted, to which reference is made below.

In the bottom region, the outer contour of the main body 6 is matched in such a way to the contour of the receiving groove 4 that the main body 6 can be inserted laterally into the receiving grooves 4 and then rests in a substantially form-fitting manner against the wall of the receiving groove. In the present case, the main body 6 has for this purpose projections 8 which protrude on both sides in the Y direction and which engage in the corresponding undercuts 9 of the dovetail receiving grooves 4. A continuous recess 10, into which tool plates 11, each provided with an abrasive surface 5, are inserted and screwed to the main body 6, in each case extends in the X direction along the upward-facing surface sections of the projections 8 of the main body 6. In the present case, the abrasive surfaces 5 are in each case formed by a diamond coating, which defines a grinding surface. A plurality of rolling elements 12, which in the present case are arranged in alignment with one another in the X direction, protrudes from a central region of the bottom side of the main body 6. The rolling elements 12 are arranged detachably, by means of corresponding screwed joints, on a rolling element plate 13, which is recessed into the main body 6 and is held on the latter by means of holding screws 14. In this case, the holding screws 14 are inserted from above into corresponding through holes 15 in the main body 6 and are supported in such a way against the main body 6, by means of an associated return spring 16, that the rolling element plate 13 can move downward relative to the main body 6 against the spring force of the return springs 16. An adjusting means or adjustment 17 is furthermore provided, upon the actuation of which the rolling element plate 13 is pressed resiliently downward against the spring force of the return springs 16. In the present case, the adjusting means or adjustment 17 comprises an adjusting screw 18, which is screwed from above into a through hole 20 in the main body 6, the through hole being provided with an internal thread 19 and extending as far as the rolling element plate 13, and has a compression spring 21 accommodated in the through hole 20, which is supported, on the one hand, against the adjusting screw 18 and, on the other hand, against the rolling element plate 13.

Even though the main body 6 can in principle be of single-part design, it is divided in the present case into three parts in the longitudinal direction, namely into two side parts 22 of identical construction and a central part 23, on which the handle 7, the rolling element plate 13 and the adjusting means or adjustment 17 are arranged. In the present case, the side parts 22 are mounted in a form-fitting manner from above on the central part 23, this being achieved by means of corresponding dovetail joints 24.

The fixing of the side parts 22 on the central part 23 is in each case accomplished by means of a quick release fastener 25. Each quick release fastener 25 comprises a quick release lever 26, which is arranged approximately centrally on the corresponding side part 22 and is pivotable about a pivot pin 27 extending in the Y direction. Toothing 28 projects downward from the quick release lever 26 and, when the quick release lever 26 is pivoted downward around the pivot pin 27, the toothing engages in corresponding mating toothing 29 of a sliding element 30, which is held on the side part 22 in such a way as to be movable back and forth in the X direction. The sliding movement of the sliding element 30 is limited in the direction of the free end of the side part 22 by a stop pin 31. In the opposite direction, the sliding element 30 rests against a locking pin 32, which is accommodated in a through opening 33, extending in the X direction, in the side part 22 and is pushed in the direction of the sliding element 30 by means of a return spring 34. In the locked state, the opposite, free end of the locking pin 32 engages in a recess 35 in the central part 23, the recess being formed in alignment with the through opening 33.

The dressing tool 1 is transported in the disassembled state. In order to clean receiving grooves 4 of a rotor 2 of an axial flow machine 3 using the dressing tool 1, in particular to free them from oxide layers, the dressing tool 1 must be assembled in a first step. For this purpose, the side parts 22 are each mounted from above on the central part 23 with the quick release fastener 25 open. The quick release levers 26 are then moved downward in a pivoting motion around the pivot pins 27 thereof, wherein the toothings 28 engage in the associated mating toothings 29 of the sliding elements 30, with the result that these are moved in the direction of the central part 23 against the spring force of the return springs 34 and push the locking pins 32 into the recesses 35 of the central part 23. In a further step, the now assembled main body 6 is inserted into the receiving groove 4 to be dressed, as shown in FIG. 6. After this, the adjusting screw 18 of the adjusting means or adjustment 17 is screwed in by a predetermined amount, thereby moving the roller element plate 13 downward against the spring forces of the return springs 16 by way of the compression spring 21. In this way, the abrasive surfaces 5 are pressed against the wall of the receiving groove 4 with a predetermined force, depending on the screw-in depth of the adjusting screw 18. The surface of the receiving groove 4 can now be dressed by gripping the handle 7 of the dressing tool 1 manually and moving the main body 6 back and forth within the receiving groove 4, wherein the main body 6 acts as a guide body during this movement. The rolling elements 12 assist this movement. The resilient contact pressure force furthermore prevents tilting of the main body 6 within the receiving groove 4 during the back-and-forth movement.

To adjust the contact pressure force acting via the adjusting screw 18, a scale 36 can be provided on the central part 23, thereby making it possible, in particular, to improve the reproducibility of a dressing operation. However, the scale 36 should be regarded as an optional feature.

In the case of wearing of an abrasive surface 5, the associated tool plate 11 can simply be removed and replaced by a new tool plate 11.

Although the present invention has been disclosed in the form of preferred embodiments and variations thereon, it will be understood that numerous additional modifications and variations could be made thereto without departing from the scope of the intention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A method for cleaning a receiving groove formed on a rotor of an axial flow machine, the receiving groove serving to receive a blade root of a rotor blade, in which an elongate main body of a dressing tool, the main body being provided with at least one abrasive surface at least in some region or regions, is introduced into the receiving groove and is moved back and forth therein while dressing is performed, wherein an outer contour of the main body is matched in such a way to the contour of the receiving groove to be cleaned that, when the main body is in the state inserted into the receiving groove, it rests against the wall of the receiving groove in a substantially form-fitting manner in such a way that it acts as a guide body during the back-and-forth movement.

2. The method as claimed in claim 1, wherein the at least one abrasive surface is pressed against the wall of the receiving groove by a spring force during the dressing process.

3. The method as claimed in claim 1, wherein the spring force is adjustable.

4. The method as claimed in claim 1, wherein the main body is moved manually within the receiving groove.

5. A dressing tool for carrying out a method as claimed in claim 1, comprising an elongate main body provided with at least one abrasive surface, the outer contour of which is matched in such a way to the contour of the receiving groove to be cleaned that it can be inserted in a substantially form-fitting manner into the receiving groove and acts as a guide body.

6. The dressing tool as claimed in claim 5, wherein rolling elements protrude from the bottom side of the main body.

7. The dressing tool as claimed in claim 6, wherein the rolling elements are arranged on a rolling element plate, which is held on the main body in such a way as to be downwardly movable against the spring force of at least one return spring, and in that an adjustment is provided, upon the actuation of which the rolling element plate is pressed resiliently downward against the spring force of the at least one return spring.

8. The dressing tool as claimed in claim 7, wherein the adjustment has an adjusting screw, which is screwed from above into a through hole in the main body, through hole being provided with an internal thread and extending as far as the rolling element plate, and has a compression spring accommodated in the through hole, which is supported, on the one hand, against the adjusting screw and, on the other hand, against the rolling element plate.

9. The dressing tool as claimed in claim 5, wherein the at least one abrasive surface is designed as a grinding surface, in particular in the form of a diamond coating.

10. The dressing tool as claimed in claim 5, wherein the at least one abrasive surface is fastened detachably on the main body, in particular in the form of a tool plate, which is provided with the abrasive surface and is accommodated in a recess formed in the main body.

11. The dressing tool as claimed in claim 5, wherein the at least one abrasive surface is arranged on an upward-facing surface section of a laterally protruding projection of the main section.

12. The dressing tool as claimed in claim 5, wherein the main body is divided into three parts in the longitudinal direction, which are fastened to one another by means of quick release fasteners.

13. The dressing tool as claimed in claim 5, wherein an upward-protruding handle is secured on the main body.
